(19) United States
(12) Patent Application Publication
(10) Pub. No.: US 2016/0239849 A1
(43) Pub. Date: Aug. 18, 2016

(54) SYSTEM AND METHOD FOR VALIDATION OF AUTO INSURANCE THROUGH A DRIVERS MOBILE DEVICE

(71) Applicant: CloudCar, Inc., Mountain View, CA (US)

(72) Inventor: Konstantin Othmer, Los Altos, CA (US)

(21) Appl. No.: 15/042,096

(22) Filed: Feb. 11, 2016

Related U.S. Application Data
(60) Provisional application No. 62/115,400, filed on Feb. 12, 2015.

(51) Int. Cl. G06Q 30/00

(52) U.S. Cl. CPC G06Q 30/018

(57) ABSTRACT

A system and method for validation of auto insurance through a driver's mobile device are disclosed. A particular embodiment includes: pairing a mobile device with an in-vehicle control system having an insurance status processing module, the in-vehicle control system being resident in a vehicle; transferring an electronic insurance certificate retained on the mobile device to the in-vehicle control system; authenticating the electronic insurance certificate by use of the insurance status processing module, the authenticating including comparing data in the electronic insurance certificate against related insurance data in a valid insurance certificate; and enabling, disabling, or modifying the operation of the vehicle based on the authentication of the electronic insurance certificate.

### PRIORITY PATENT APPLICATION

This is a non-provisional patent application drawing priority from co-pending U.S. provisional patent application Ser. No. 62/115,400; filed Feb. 12, 2015. This present non-provisional patent application draws priority from the referenced provisional patent application. The entire disclosure of the referenced patent application is considered part of the disclosure of the present application and is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2012-2016, CloudCar Inc., All Rights Reserved.

### TECHNICAL FIELD

This patent document pertains generally to tools (systems, apparatuses, methodologies, computer program products, etc.) for allowing electronic devices to share information with each other, and more particularly, but not by way of limitation, to a system and method for validation of auto insurance through a driver's mobile device.

### BACKGROUND

Laws require drivers to have proof of insurance in order to drive a vehicle. Today, drivers typically carry an insurance card to show proof of insurance for driver and vehicle, Insurance can be verified electronically each year by the State's Department of Motor Vehicles (DMV) or by police. There are also new smartphone applications (apps) that allow the display of insurance details for visual verification. State of the art systems now exist to track the geographic location of a vehicle so insurance companies can obtain accurate information on a vehicle's usage patterns. Other conventional systems require that a vehicle is equipped with a special scanner to scan an insurance card. However, none of the systems today allow the enforcement of valid insurance status using a portable electronic device.

### BRIEF DESCRIPTION OF THE DRAWINGS

The various embodiments are illustrated by way of example, and not by way of limitation, in the figures of the accompanying drawings in which:

FIG. 1 illustrates a block diagram of an example ecosystem in which an in-vehicle insurance status processing module of an example embodiment can be implemented;

FIG. 2 illustrates the components of the in-vehicle insurance status processing module of an example embodiment;

FIGS. 3 and 4 are process flow diagrams illustrating an example embodiment of a system and method for validation of auto insurance through a driver's mobile device; and

FIG. 5 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

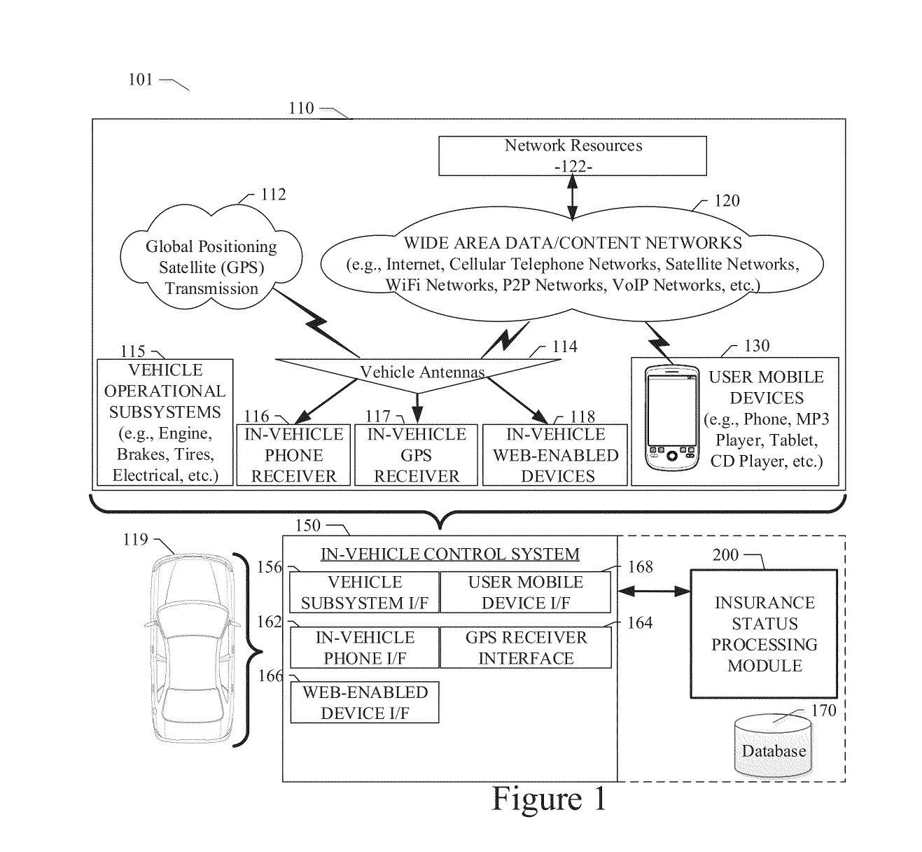

As described in various example embodiments, a system and method for validation of auto insurance through a driver's mobile device are described herein. In one example embodiment, an in-vehicle control system with an insurance status processing module resident in a vehicle can be configured like the architecture illustrated in FIG. 1. However, it will be apparent to those of ordinary skill in the art that the insurance status processing module described and claimed herein can be implemented, configured, and used in a variety of other applications and systems as well.

Referring now to FIG. 1, a block diagram illustrates an example ecosystem 101 in which an in-vehicle control system 150 and an insurance status processing module 200 of an example embodiment can be implemented. These components are described in more detail below. Ecosystem 101 includes a variety of systems and components that can generate and/or deliver one or more sources of information/data and related services to the in-vehicle control system 150 and the insurance status processing module 200, which can be installed in a vehicle 119. For example, a standard Global Positioning Satellite (GPS) network 112 can generate position and timing data or other navigation information that can be received by an in-vehicle GPS receiver 117 via vehicle antenna 114. The in-vehicle control system 150 and the insurance status processing module 200 can receive this timing data and navigation information via the GPS receiver interface 164, which can be used to connect the in-vehicle control system 150 with the in-vehicle GPS receiver 117 to obtain the timing data and navigation information.

Similarly, ecosystem 101 can include a wide area data/content network 120. The network 120 represents one or more conventional wide area data/content networks, such as the Internet, a cellular telephone network, satellite network, pager network, a wireless broadcast network, gaming network, WiFi network, peer-to-peer network, Voice over IP (VoIP) network, etc. One or more of these networks 120 can be used to connect a user or client system with network resources 122, such as websites, servers, call distribution sites, headend content delivery sites, or the like. The network resources 122 can generate and/or distribute data, which can be received in vehicle 119 via one or more antennas 114. Antennas 114 can serve to connect the in-vehicle control system 150 and the insurance status processing module 200 with the data/content network 120 via cellular, satellite, radio, or other conventional signal reception mechanisms. Such cellular data or content networks are currently available (e.g., Verizon™, AT&T™, T-Mobile™, etc.). Such satellite-based data or content networks are also currently available (e.g., SiriusXM™, HughesNet™, etc.). The conventional broadcast networks, such as AM/FM radio networks, pager networks, UHF networks, gaming networks, WiFi networks, peer-to-peer networks, Voice over IP (VoIP) networks, and the like are also well-known. Thus, as described in more detail below, the in-vehicle control system 150 and the insurance status processing module 200 can receive telephone calls and/or phone-based data transmissions via an in-vehicle phone interface 162, which can be used to connect with the in-vehicle phone receiver 116 and network 120. The in-vehicle control system 150 and the insurance status processing module 200 can receive web-based data or content via an in-vehicle web-enabled device interface 166, which can be used to connect with the in-vehicle web-enabled device receiver 118 and network 120. In this manner, the in-vehicle control system 150 and the insurance status processing module 200 can support a variety of network-connectable in-vehicle devices and systems from within a vehicle 119.

As shown in FIG. 1, the in-vehicle control system 150 and the insurance status processing module 200 can also receive data and content from user mobile devices 130, which are located proximately to the vehicle 119. The user mobile devices 130 can represent standard mobile devices, such as cellular phones, smartphones, personal digital assistants (PDA's), MP3 players, tablet computing devices (e.g., iPad), laptop computers, CD players, and other mobile devices, which can produce and/or deliver data and content for the in-vehicle control system 150 and the insurance status processing module 200. As shown in FIG. 1, the mobile devices 130 can also be in data communication with the network cloud 120. The mobile devices 130 can source data and content from internal memory components of the mobile devices 130 themselves or from network resources 122 via network 120. In either case, the in-vehicle control system 150 and the insurance status processing module 200 can receive this data and content from the user mobile devices 130 as shown in FIG. 1.

In various embodiments, the mobile device 130 interface and user interface between the in-vehicle control system 150 and the mobile devices 130 can be implemented in a variety of ways. For example, in one embodiment, the mobile device 130 interface between the in-vehicle control system 150 and the mobile devices 130 can be implemented using a Universal Serial Bus (USB) interface and associated connector.

In another embodiment, the interface between the in-vehicle control system 150 and the mobile devices 130 can be implemented using a wireless protocol, such as WiFi or Bluetooth™ (BT). WiFi is a popular wireless technology allowing an electronic device to exchange data wirelessly over a computer network. Bluetooth™ is a wireless technology standard for exchanging data over short distances. Using standard mobile device 130 interfaces, a mobile device 130 can be paired and/or synchronized with the in-vehicle control system 150 when the mobile device 130 is moved within a proximity region of the in-vehicle control system 150. The user mobile device interface 168 can be used to facilitate this pairing. Once the in-vehicle control system 150 is paired with the mobile device 130, the mobile device 130 can share information with the in-vehicle control system 150 and the insurance status processing module 200 in data communication therewith.

Referring again to FIG. 1 in an example embodiment as described above, the in-vehicle control system 150 and the insurance status processing module 200 can receive navigation data, information, and/or other types of data and content from a variety of sources in ecosystem 101, both local (e.g., within proximity of the in-vehicle control system 150) and remote (e.g., accessible via data network 120). These sources can include wireless broadcasts, data and content from proximate user mobile devices 130 (e.g., a mobile device proximately located in or near the vehicle 119), data and content from network 120 cloud-based resources 122, an in-vehicle phone receiver 116, an in-vehicle GPS receiver or navigation system 117, in-vehicle web-enabled devices 118, or other in-vehicle devices that produce or distribute data and/or content.

Referring still to FIG. 1, the example embodiment of ecosystem 101 can include vehicle operational subsystems 115. For embodiments that are implemented in a vehicle 119, many standard vehicles include operational subsystems, such as electronic control units (ECUs), supporting monitoring/control subsystems for the engine, brakes, transmission, electrical system, emissions system, interior environment, and the like. For example, data signals communicated from the vehicle operational subsystems 115 (e.g., ECUs of the vehicle 119) to the in-vehicle control system 150 via vehicle subsystem interface 156 may include information about the state of one or more of the components or subsystems of the vehicle 119. In particular, the data signals, which can be communicated from the vehicle operational subsystems 115 to a Controller Area Network (CAN) bus of the vehicle 119, can be received and processed by the in-vehicle control system 150 and the insurance status processing module 200 via vehicle subsystem interface 156. Embodiments of the systems and methods described herein can be used with substantially any mechanized system that uses a CAN bus or similar data communications bus as defined herein, including, but not limited to, industrial equipment, boats, trucks, machinery, or automobiles; thus, the term “vehicle” as used herein can include any such mechanized systems. Embodiments of the systems and methods described herein can also be used with any systems employing some form of network data communications; however, such network communications are not required.

In the example embodiment shown in FIG. 1, the in-vehicle control system 150 can also include a rendering system to enable a user to view and/or hear information, content, and control prompts provided by the in-vehicle control system 150. The rendering system can include standard visual display devices (e.g., plasma displays, liquid crystal displays (LCDs), touchscreen displays, heads-up displays, or the like) and speakers or other audio output devices.

Additionally, other data and/or content (denoted herein as ancillary data) can be obtained from local and/or remote sources by the in-vehicle control system 150 as described above. The ancillary data can be used to augment or modify the operation of the insurance status processing module 200 based on a variety of factors including, user context (e.g., the identity, age, profile, and driving history of the user), the context in which the user is operating the vehicle (e.g., the location of the vehicle, the specified destination, direction of travel, speed, the time of day, the status of the vehicle, etc.), and a variety of other data obtainable from a variety of sources, local and remote.

In a particular embodiment, the in-vehicle control system 150 and the insurance status processing module 200 can be implemented as in-vehicle components of vehicle 119. In various example embodiments, the in-vehicle control system 150 and the insurance status processing module 200 in data communication therewith can be implemented as integrated components or as separate components. In an example embodiment, the software components of the in-vehicle control system 150 and/or the insurance status processing module 200 can be dynamically upgraded, modified, and/or augmented by use of the data connection with the mobile devices 130 and/or the network resources 122 via network 120. The in-vehicle control system 150 can periodically query a mobile device 130 or a network resource 122 for updates or updates can be pushed to the in-vehicle control system 150.

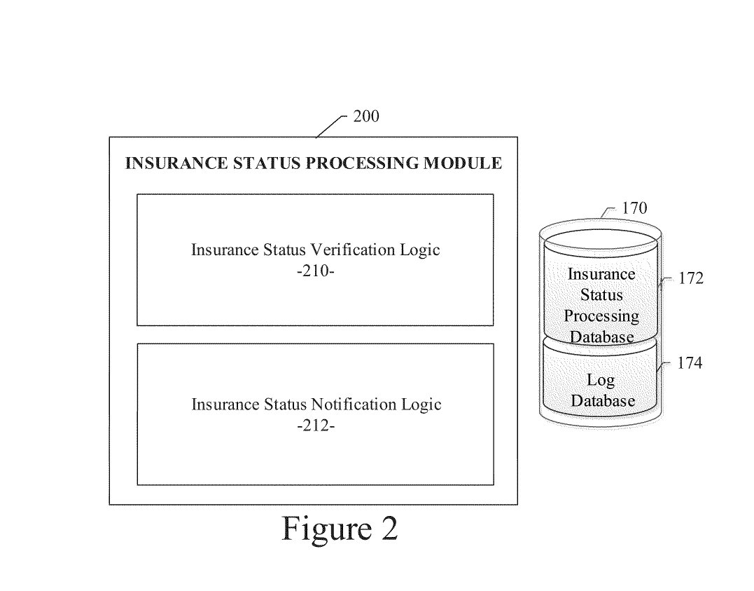

Referring now to FIG. 2, the diagram illustrates the components of the insurance status processing module 200 of an example embodiment. In the example embodiment, the insurance status processing module 200 can be configured to include an interface with the in-vehicle control system 150, as shown in FIG. 1, through which the insurance status processing module 200 can send and receive data as described above. Additionally, the insurance status processing module 200 can be configured to include an interface with the in-vehicle control system 150 and/or other ecosystem 101 subsystems through which the insurance status processing module 200 can receive ancillary data from the various data and content sources as described above.

In an example embodiment as shown in FIG. 2, the insurance status processing module 200 can be configured to include an insurance status verification logic module 210 and an insurance status notification logic module 212. Each of these modules can be implemented as software, firmware, or other logic components executing or activated within an executable environment of the insurance status processing module 200 operating within or in data communication with the in-vehicle control system 150. Each of these modules of an example embodiment is described in more detail below in connection with the figures provided herein.

The insurance status verification logic module 210 of an example embodiment is responsible for verifying and authenticating an electronic insurance certificate received from an external source, such as a mobile device 130 or a network resource 122 via network 120. As described above, the insurance status processing module 200 can receive data from the in-vehicle control system 150 via user mobile device interface 168 or web-enabled device interface 166. As such, a mobile device 130 can be used to obtain an electronic insurance certificate from an authorized source, such as an insurance provider. Because of the mobility of these devices, it is convenient to use these devices for the secure transfer of the electronic insurance certificate from the insurance provider to the insurance status processing module 200.

As well-known in the insurance industry, insurance providers can produce a proof of insurance document that validates that a particular insured party has obtained the legally required insurance for a particular vehicle. Using well-known techniques, such proof of insurance documents can be converted to a digital form, which can be transferred via conventional data networks. Moreover, such digital proof of insurance documents can be secured using a variety of standard techniques, such as digital signatures, watermarks, public/private encryption, steganographic techniques, or the like. As a result, insurance providers can produce a proof of insurance document including vehicle insurance information in a secure digital form (e.g., an electronic insurance certificate) that can be transferred to a mobile device 130 in a data network transfer. Conventional data transfer techniques can be used to accomplish this transfer of the electronic insurance certificate to the mobile device 130. A mobile device application (app) can be installed on the mobile device 130 using well-known techniques. The app can be used to receive the electronic insurance certificate at the mobile device 130 in a secure manner and to decrypt the electronic insurance certificate or otherwise render the electronic insurance certificate decipherable.

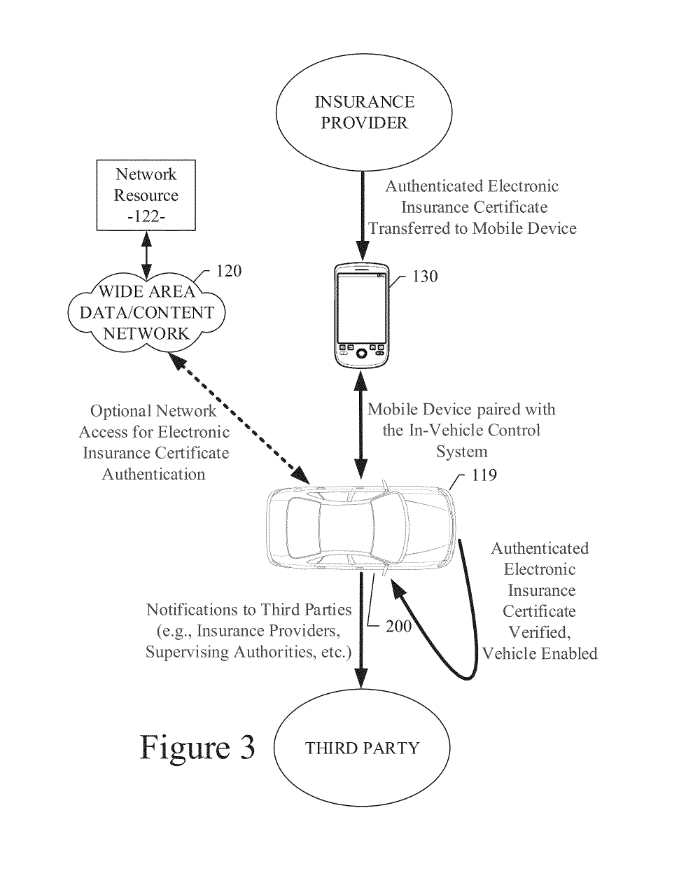

Referring now to FIG. 3, a process flow diagram illustrates an example embodiment of the system and method for validation of auto insurance through a driver's mobile device. In the illustrated sample process, an insurance provider or other secure electronic insurance certificate source can transfer an electronic insurance certificate to a mobile device 130 in a secure manner as described above. Once the electronic insurance certificate is resident in the mobile device 130, the mobile device 130 can be moved to a geographical location within or proximate to the vehicle 119. As described above, the mobile device 130 can be paired and/or synchronized with the in-vehicle control system 150 when the mobile device 130 is moved within a proximity region of the in-vehicle control system 150 of vehicle 119. The user mobile device interface 168 can be used to facilitate this pairing. Once the in-vehicle control system 150 is paired with the mobile device 130, the mobile device 130 can share information with the in-vehicle control system 150 and the insurance status processing module 200 in data communication therewith. As a result, the insurance status processing module 200 in vehicle 119 can obtain the electronic insurance certificate from the mobile device 130. The app within mobile device 130 can decrypt or otherwise decipher the electronic insurance certificate and produce a readable/useable version of the electronic insurance certificate for the insurance status processing module 200. Alternatively, the mobile device 130 can transfer the encrypted electronic insurance certificate to the insurance status processing module 200 for decryption by the insurance status processing module 200. A pre-configured private key or other decryption mechanism can be installed in the insurance status processing module 200 or the in-vehicle control system 150 to facilitate decryption of the electronic insurance certificate. Ultimately, the insurance status processing module 200 running in vehicle 119 can obtain access to the received electronic insurance certificate produced by the insurance provider and transferred via the mobile device 130.

Referring still to FIG. 3, the insurance status processing module 200 can compare the data in the received electronic insurance certificate against related insurance data in a valid insurance certificate retained in a persistent memory of the in-vehicle control system 150 (e.g., retained in an insurance processing status database 172 shown in FIG. 2). The valid insurance certificate can be pre-loaded into the persistent memory of the in-vehicle control system 150 during a secure system configuration operation. Alternatively, the insurance status processing module 200 can initiate a network access to a network resource 122 via network 120. This network access can be accomplished in a manner described in detail above. The network resource 122 can be an insurance certificate authentication server that can provide the valid insurance certificate data used to compare with the data in the received electronic insurance certificate. Using either a locally-stored or network-resident valid insurance certificate, the insurance status processing module 200 can determine if the received electronic insurance certificate can be authenticated relative to the valid insurance certificate data. For example, the insurance status processing module 200 can validate that the vehicle identification number (VIN) or the license number of the vehicle on the received electronic insurance certificate matches the corresponding data of the valid insurance certificate. Similarly, the insurance status processing module 200 can validate that the name of the insured on the received electronic insurance certificate matches the corresponding data of the valid insurance certificate. Moreover, the insurance status processing module 200 can validate that the insurance coverage dates on the received electronic insurance certificate match the corresponding data of the valid insurance certificate and/or the current date. It will be apparent to those of ordinary skill in the art in view of the disclosure herein that a variety of other validation/authentication checks or tests can be performed by the insurance status processing module 200 to validate or authenticate the received electronic insurance certificate and the vehicle insurance coverage related thereto. As a result, the received electronic insurance certificate can be either accepted/authenticated or rejected/not authenticated by the insurance status processing module 200.

Based on the electronic insurance certificate authentication performed by the insurance status processing module 200 of an example embodiment, the operation of the vehicle 119 (and the individual subsystems therein) can be enabled, disabled, and/or modified in a variety of ways as directed by the insurance status processing module 200 and the in-vehicle control system 150 connected therewith. For example, as described above, the in-vehicle control system 150 includes a vehicle subsystem interface 156 through which the in-vehicle control system 150 can monitor and control various subsystems of the vehicle 119. One such subsystem is the vehicle 119 ignition and electrical subsystem. In one example embodiment, the insurance status processing module 200 can direct the in-vehicle control system 150 to cause the vehicle ignition and electrical subsystem to become disabled if the received electronic insurance certificate is rejected/not authenticated by the insurance status processing module 200 (e.g., a denial of vehicle service based on electronic insurance certificate status). In other example embodiments, the insurance status processing module 200 can direct the in-vehicle control system 150 to cause the vehicle engine and fuel subsystem to limit the speed and/or acceleration of the vehicle 119 if the received electronic insurance certificate is rejected/not authenticated by the insurance status processing module 200. Alternatively, the insurance status processing module 200 can direct the in-vehicle control system 150 to cause the vehicle engine and fuel subsystem to limit the speed and/or acceleration of the vehicle 119 if the received electronic insurance certificate is authenticated; yet, the data retrieved from the electronic insurance certificate is indicative of a pre-determined use limitation imposed on the driver or the vehicle (e.g., a modification or limitation of vehicle service based on electronic insurance certificate status). In other example embodiments, the insurance status processing module 200 can modify or impose limitations on the operation of vehicle 119 in a variety of other ways based on the data received in the electronic insurance certificate. For example, the operation of the vehicle 119 can be restricted to operation only in specific geographical areas, specific times of the day or days of the week, or operation only with a specific driver based on the information in the electronic insurance certificate. Additionally, the operation of specific vehicle subsystems can be modified, enabled, or disabled based on the information in the electronic insurance certificate. For example, the operation of the phone subsystem or media subsystem can be modified or disabled to reduce the occurrence of distracted driving. Alternatively, the audio volume of the phone subsystem or media subsystem can be automatically reduced or the microphone input can be automatically muted to reduce driver distractions. The operation of a high-performance transmission, manual sport transmission, or four-wheel drive in vehicle 119 can be automatically disabled to reduce the possibility of reckless or off-road driving by particular drivers as determined from information obtained from the electronic insurance certificate. The operation of the navigation system can be disabled or modified to prevent a particular driver from navigating to prohibited destinations or outside limited areas. The operation of airbag deployment subsystems or other vehicle safety subsystems can also be modified based on the presentation of an electronic insurance certificate of a particular individual. As such, the operation of the vehicle 119 and the various subsystems therein can be specifically tailored, enabled, disabled, or modified based on the particular individual/driver associated with the electronic insurance certificate presented to the vehicle 119 via the mobile device 130.

In another example embodiment, the status or configuration of the vehicle 119 can be dynamically configured or modified based on the preferences of the individual associated with the electronic insurance certificate presented to the vehicle 119 via the mobile device 130 as described above. For example, a driver associated with a particular electronic insurance certificate can create or edit an on-line preferences profile to specify the particular vehicle subsystem preferences preferred by the driver. In this manner, the driver can specify navigation subsystem preferences, such as home location, work location, preferred routes, preferred enroute vendors, etc. The driver can also specify vehicle safety and comfort subsystem preferences, such as side mirror position, seat position, window position, heads-up display operation, etc. The driver can also specify vehicle phone subsystem or media subsystem preferences, such as enable/disable the phone, favorite radio stations, favorite play lists, audio volume, treble/base selection, balance selection, audio source selection, etc. It will be apparent to those of ordinary skill in the art in view of the disclosure herein that a variety of other driver preferences can be received and stored in a driver preferences profile. When a particular driver presents his/her electronic insurance certificate, the insurance status processing module 200 can first authenticate the electronic insurance certificate as described above. Once authenticated, the insurance status processing module 200 can retrieve the preferences profile associated with the driver presenting the authenticated electronic insurance certificate. Then, the insurance status processing module 200 can direct the vehicle 119 subsystems to configure their status and operation in a manner consistent with the data stored in the driver's preference profile. In this manner, the status and operation of the vehicle 119 can be automatically configured and customized for the driver when the driver presents the authenticated electronic insurance certificate to the in-vehicle control system 150 and the insurance status processing module 200 in data communication therewith.

Alternatively, the in-vehicle control system 150 can automatically sense the configurations and settings explicitly applied by the driver as the driver operates the vehicle 119. For example, the in-vehicle control system 150 and/or the insurance status processing module 200 can determine that a particular driver associated with a particular electronic insurance certificate typically moves his/her seat to a particular position, selects the same radio station, selects the same destination location, and consistently adjusts the mirrors to a particular position. The insurance status processing module 200 can automatically update the driver's preferences profile based on these explicit driver actions in the vehicle 119. Thus, as described above, the in-vehicle control system 150 and the insurance status processing module 200 of various embodiments can obtain an electronic insurance certificate from a mobile device 130, authenticate the electronic insurance certificate using data retained in the in-vehicle control system 150 or obtained via a network access, and enable, disable, or modify the operation of a vehicle paired with the mobile device 130 on which the electronic insurance certificate is stored and transferred.

In an example embodiment shown in FIGS. 2 and 3, the insurance status processing module 200 can include an insurance status notification logic module 212. The insurance status notification logic module 212 of an example embodiment is responsible for notifying pre-configured and approved third parties of the use of an electronic insurance certificate. For example, the insurance status notification logic module 212 can be configured to send an electronic message (e.g., an email, an SMS text message, a tweet, a datagram, or other data transmission) to one or more pre-determined recipients, such as an insurance provider, a vehicle dispatch or control center, a parent or guardian, a law enforcement agency, a government agency (e.g., NHTSA—National Highway Traffic Safety Administration), or any other third party recipient. The electronic message can be configured to be automatically sent when the mobile device 130 having the electronic insurance certificate is paired with a vehicle, when the electronic insurance certificate is authenticated, when the electronic insurance certificate is denied, if the insurance coverage associated with the electronic insurance certificate is determined to be lapsed or not covered, and/or when the vehicle or driver associated with a particular electronic insurance certificate operates the vehicle in a manner that exceeds pre-defined operational limits. The automatically transmitted electronic message can also be triggered by a variety of other pre-determined events or conditions, including vehicle operation outside of a limited area or timeframe, vehicle operation while texting or using the phone, detection of a vehicle subsystem fault, detection of erratic driving, or a variety of other events or conditions. The automatically transmitted electronic message can include data or information indicative of the status or condition of the vehicle and the events or conditions that triggered the electronic message. The insurance status notification logic module 212 of an example embodiment can also be configured to receive electronic messages back from various third parties. For example, a third party can return an acknowledgement when the third party receives an automatically transmitted electronic message from the insurance status notification logic module 212. A third party can also return information related to corrective action that can be taken to correct the condition that triggered the automatically transmitted electronic message sent by the insurance status notification logic module 212. For example, if a particular electronic insurance certificate indicates that insurance coverage for a particular vehicle has lapsed and a resulting automatically transmitted electronic message is sent to a third party by the insurance status notification logic module 212, the third party can respond to the insurance status notification logic module 212 with information related to solutions available to obtain or purchase new or additional insurance coverage.

An example embodiment can also record or log parameters associated with the electronic insurance certificate authentication performed by the insurance status processing module 200. An example embodiment can also record or log parameters associated with the operation of the vehicle. These log parameters can be stored in log database 174 of database 170 as shown in FIG. 2. The log parameters can be used as a historical reference to retain information related to the manner in which a particular electronic insurance certificate was previously analyzed and the results produced by the analysis. This historical data can be used in the subsequent analysis of a same or similar electronic insurance certificate.

Thus, as described herein in various example embodiments, the insurance status processing module 200 can link a particular electronic insurance certificate retained in a mobile device with a particular driver and a particular vehicle. As a result, the operation of the vehicle can be tightly and configurably controlled based on the presence of the particular driver and the mobile device with the particular electronic insurance certificate. Therefore, the various embodiments effectively link a driver with a vehicle. This link between the driver and vehicle enabled by the described embodiments provides several advantages. The various embodiments enable the insurance company to know who is driving the vehicle, how much they are driving, how they are driving, where they are driving, etc. The various embodiments enable the vehicle operation information to be tied to a specific person. Secondly, for parents or regulators, the various embodiments provide a way to enforce behaviors like,“don't text and drive.” Because vehicle subsystem operation can be tied to a specific person as described herein, the insurance status processing module 200 can disable operation of the phone if the vehicle is in motion. A variety of other behaviors can also be enforced as described above. Regulators, such as NHSTA, now have a way to strengthen guidelines and potentially pass laws that improve traffic safety.

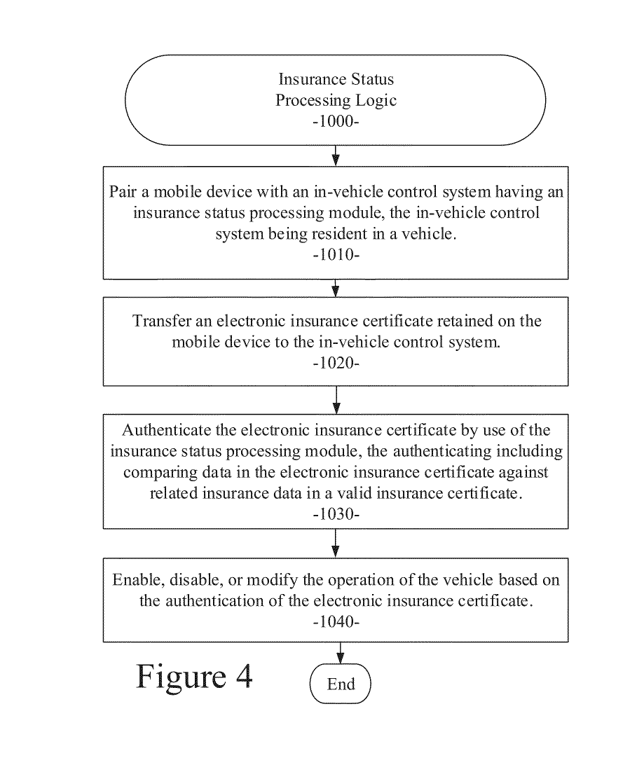

Referring now to FIG. 4, a flow diagram illustrates an example embodiment of a system and method 1000 for validation of auto insurance through a driver's mobile device. The example embodiment includes: pairing a mobile device with an in-vehicle control system having an insurance status processing module, the in-vehicle control system being resident in a vehicle (processing block 1010); transferring an electronic insurance certificate retained on the mobile device to the in-vehicle control system (processing block 1020); authenticating the electronic insurance certificate by use of the insurance status processing module, the authenticating including comparing data in the electronic insurance certificate against related insurance data in a valid insurance certificate (processing block 1030); and enabling, disabling, or modifying the operation of the vehicle based on the authentication of the electronic insurance certificate (processing block 1040).

As used herein and unless specified otherwise, the term “mobile device” includes any computing or communications device that can communicate with the in-vehicle control system 150 and/or the insurance status processing module 200 described herein to obtain read or write access to data signals, messages, or content communicated via any mode of data communications. In many cases, the mobile device 130 is a handheld, portable device, such as a smart phone, mobile phone, cellular telephone, tablet computer, laptop computer, display pager, radio frequency (RF) device, infrared (IR) device, global positioning device (GPS), Personal Digital Assistants (PDA), handheld computers, wearable computer, portable game console, other mobile communication and/or computing device, or an integrated device combining one or more of the preceding devices, and the like. Additionally, the mobile device 130 can be a computing device, personal computer (PC), multiprocessor system, microprocessor-based or programmable consumer electronic device, network PC, diagnostics equipment, a system operated by a vehicle 119 manufacturer or service technician, and the like, and is not limited to portable devices. The mobile device 130 can receive and process data in any of a variety of data formats. The data format may include or be configured to operate with any programming format, protocol, or language including, but not limited to, JavaScript™, C++, iOS, Android™, etc.

As used herein and unless specified otherwise, the term “network resource” includes any device, system, or service that can communicate with the in-vehicle control system 150 and/or the insurance status processing module 200 described herein to obtain read or write access to data signals, messages, or content communicated via any mode of inter-process or networked data communications. In many cases, the network resource 122 is a data network accessible computing platform, including client or server computers, websites, mobile devices, peer-to-peer (P2P) network nodes, and the like. Additionally, the network resource 122 can be a web appliance, a network router, switch, bridge, gateway, diagnostics equipment, a system operated by a vehicle 119 manufacturer or service technician, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein. The network resources 122 may include any of a variety of providers or processors of network transportable digital content. Typically, the file format that is employed is Extensible Markup Language (XML), however, the various embodiments are not so limited, and other file formats may be used. For example, data formats other than Hypertext Markup Language (HTML)/XML or formats other than open/standard data formats can be supported by various embodiments. Any electronic file format, such as Portable Document Format (PDF), audio (e.g., Motion Picture Experts Group Audio Layer 3-MP3, and the like), video (e.g., MP4, and the like), and any proprietary interchange format defined by specific content sites can be supported by the various embodiments described herein.

The wide area data network 120 (also denoted the network cloud) used with the network resources 122 can be configured to couple one computing or communication device with another computing or communication device. The network may be enabled to employ any form of computer readable data or media for communicating information from one electronic device to another. The network 120 can include the Internet in addition to other wide area networks (WANs), cellular telephone networks, metro-area networks, local area networks (LANs), other packet-switched networks, circuit-switched networks, direct data connections, such as through a universal serial bus (USB) or Ethernet port, other forms of computer-readable media, or any combination thereof. The network 120 can include the Internet in addition to other wide area networks (WANs), cellular telephone networks, satellite networks, over-the-air broadcast networks, AM/FM radio networks, pager networks, UHF networks, other broadcast networks, gaming networks, WiFi networks, peer-to-peer networks, Voice Over IP (VoIP) networks, metro-area networks, local area networks (LANs), other packet-switched networks, circuit-switched networks, direct data connections, such as through a universal serial bus (USB) or Ethernet port, other forms of computer-readable media, or any combination thereof. On an interconnected set of networks, including those based on differing architectures and protocols, a router or gateway can act as a link between networks, enabling messages to be sent between computing devices on different networks. Also, communication links within networks can typically include twisted wire pair cabling, USB, Firewire, Ethernet, or coaxial cable, while communication links between networks may utilize analog or digital telephone lines, full or fractional dedicated digital lines including T1, T2, T3, and T4, Integrated Services Digital Networks (ISDNs), Digital User Lines (DSLs), wireless links including satellite links, cellular telephone links, or other communication links known to those of ordinary skill in the art. Furthermore, remote computers and other related electronic devices can be remotely connected to the network via a modem and temporary telephone link.

The network 120 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. The network may also include an autonomous system of terminals, gateways, routers, and the like connected by wireless radio links or wireless transceivers. These connectors may be configured to move freely and randomly and organize themselves arbitrarily, such that the topology of the network may change rapidly. The network 120 may further employ one or more of a plurality of standard wireless and/or cellular protocols or access technologies including those set forth herein in connection with network interface 712 and network 714 described in the figures herewith.

In a particular embodiment, a mobile device 130 and/or a network resource 122 may act as a client device enabling a user to access and use the in-vehicle control system 150 and/or the insurance status processing module 200 to interact with one or more components of a vehicle subsystem. These client devices 130 or 122 may include virtually any computing device that is configured to send and receive information over a network, such as network 120 as described herein. Such client devices may include mobile devices, such as cellular telephones, smart phones, tablet computers, display pagers, radio frequency (RF) devices, infrared (IR) devices, global positioning devices (GPS), Personal Digital Assistants (PDAs), handheld computers, wearable computers, game consoles, integrated devices combining one or more of the preceding devices, and the like. The client devices may also include other computing devices, such as personal computers (PCs), multiprocessor systems, microprocessor-based or programmable consumer electronics, network PC's, and the like. As such, client devices may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and a color LCD display screen in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and send a message with relevant information.

The client devices may also include at least one client application that is configured to receive content or messages from another computing device via a network transmission. The client application may include a capability to provide and receive textual content, graphical content, video content, audio content, alerts, messages, notifications, and the like. Moreover, the client devices may be further configured to communicate and/or receive a message, such as through a Short Message Service (SMS), direct messaging (e.g., Twitter), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like. The client devices may also include a wireless application device on which a client application is configured to enable a user of the device to send and receive information to/from network resources wirelessly via the network.

The in-vehicle control system 150 and/or the insurance status processing module 200 can be implemented using systems that enhance the security of the execution environment, thereby improving security and reducing the possibility that the in-vehicle control system 150 and/or the insurance status processing module 200 and the related services could be compromised by viruses or malware. For example, the in-vehicle control system 150 and/or the insurance status processing module 200 can be implemented using a Trusted Execution Environment, which can ensure that sensitive data is stored, processed, and communicated in a secure way.

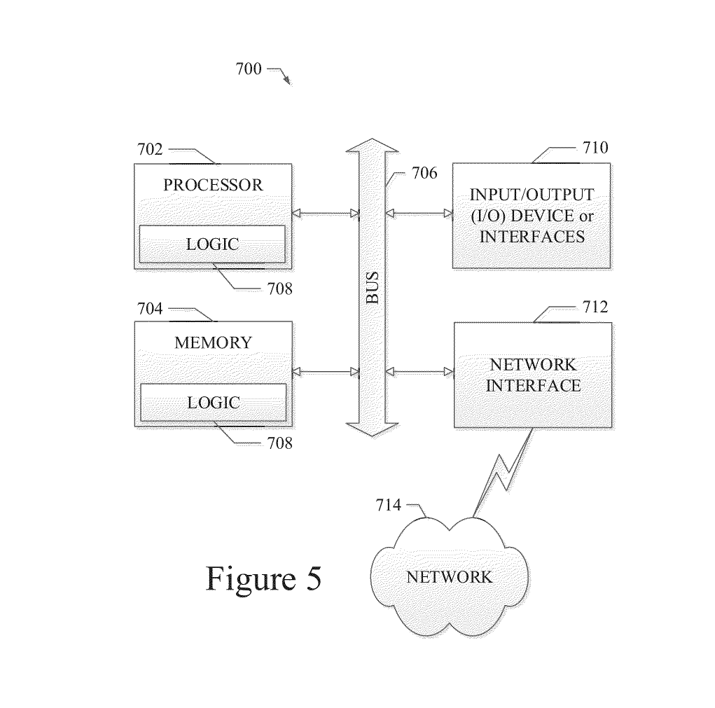

FIG. 5 shows a diagrammatic representation of a machine in the example form of a mobile computing and/or communication system 700 within which a set of instructions when executed and/or processing logic when activated may cause the machine to perform any one or more of the methodologies described and/or claimed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example mobile computing and/or communication system 700 can include a data processor 702 (e.g., a System-on-a-Chip (SoC), general processing core, graphics core, and optionally other processing logic) and a memory 704, which can communicate with each other via a bus or other data transfer system 706. The mobile computing and/or communication system 700 may further include various input/output (I/O) devices and/or interfaces 710, such as a touchscreen display, an audio jack, a voice interface, and optionally a network interface 712. In an example embodiment, the network interface 712 can include one or more radio transceivers configured for compatibility with any one or more standard wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth™, IEEE 802.11x, and the like. In essence, network interface 712 may include or support virtually any wired and/or wireless communication and data processing mechanisms by which information/data may travel between a mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system comprising:
a data processor;
an in-vehicle control system in data communication with the data processor, the in-vehicle control system being resident in a vehicle; and
an insurance status processing module being configured to:
pair a mobile device with the in-vehicle control system;
transfer an electronic insurance certificate retained on the mobile device to the in-vehicle control system;
authenticate the electronic insurance certificate, the authenticating including comparing data in the electronic insurance certificate against related insurance data in a valid insurance certificate; and
enable, disable, or modify the operation of the vehicle based on the authentication of the electronic insurance certificate.

2. The system as claimed in claim 1 wherein the electronic insurance certificate is a proof of insurance document including vehicle insurance information in a secure digital form.

3. The system as claimed in claim 1 wherein the valid insurance certificate is either stored on the in-vehicle control system or obtained via a data network access performed by the in-vehicle control system.

4. The system as claimed in claim 1 wherein the electronic insurance certificate forms a link between the vehicle and a driver pairing the mobile device with the in-vehicle control system.

5. The system as claimed in claim 1 wherein authenticating the electronic insurance certificate includes validating vehicle insurance coverage.

6. The system as claimed in claim 1 wherein enabling, disabling, or modifying the operation of the vehicle includes a denial of vehicle service based on the electronic insurance certificate status.

7. The system as claimed in claim 1 wherein enabling, disabling, or modifying the operation of the vehicle includes a modification or limitation of vehicle service based on electronic insurance certificate status.

8. The system as claimed in claim 1 being further configured to dynamically configure or modify a status or condition of the vehicle based on preferences of a driver pairing the mobile device with the in-vehicle control system.

9. The system as claimed in claim 1 being further configured to automatically transmit an electronic message to a third party when the insurance status processing module detects a particular status or condition.

10. A method comprising:
pairing a mobile device with an in-vehicle control system having an insurance status processing module, the in-vehicle control system being resident in a vehicle;
transferring an electronic insurance certificate retained on the mobile device to the in-vehicle control system;
authenticating the electronic insurance certificate by use of the insurance status processing module, the authenticating including comparing data in the electronic insurance certificate against related insurance data in a valid insurance certificate; and
enabling, disabling, or modifying the operation of the vehicle based on the authentication of the electronic insurance certificate.

11. The method as claimed in claim 10 wherein the electronic insurance certificate is a proof of insurance document including vehicle insurance information in a secure digital form.

12. The method as claimed in claim 10 wherein the valid insurance certificate is either stored on the in-vehicle control system or obtained via a data network access performed by the in-vehicle control system.

13. The method as claimed in claim 10 wherein the electronic insurance certificate forms a link between the vehicle and a driver pairing the mobile device with the in-vehicle control system.

14. The method as claimed in claim 10 wherein authenticating the electronic insurance certificate includes validating vehicle insurance coverage.

15. The method as claimed in claim 10 wherein enabling, disabling, or modifying the operation of the vehicle includes a denial of vehicle service based on the electronic insurance certificate status.

16. The method as claimed in claim 10 wherein enabling, disabling, or modifying the operation of the vehicle includes a modification or limitation of vehicle service based on electronic insurance certificate status.

17. The method as claimed in claim 10 including dynamically configuring or modifying a status or condition of the vehicle based on preferences of a driver pairing the mobile device with the in-vehicle control system.

18. The method as claimed in claim 10 including automatically transmitting an electronic message to a third party when the insurance status processing module detects a particular status or condition.

19. A non-transitory machine-useable storage medium embodying instructions which, when executed by a machine, cause the machine to:
pair a mobile device with the in-vehicle control system;
transfer an electronic insurance certificate retained on the mobile device to the in-vehicle control system;
authenticate the electronic insurance certificate, the authenticating including comparing data in the electronic insurance certificate against related insurance data in a valid insurance certificate; and
enable, disable, or modify the operation of the vehicle based on the authentication of the electronic insurance certificate.

20. The machine-useable storage medium as claimed in claim 19 wherein the electronic insurance certificate forms a link between the vehicle and a driver pairing the mobile device with the in-vehicle control system.
